(19) United States
(12) Patent Application Publication
(10) Pub. No.: US 2018/0365273 A1
(43) Pub. Date: Dec. 20, 2018

(54) DOCUMENT PROCESSING APPARATUS, METHOD AND STORAGE MEDIUM

(71) Applicant: NEC Corporation, Minato-ku, Tokyo (JP)

(72) Inventor: Kazuhiro FUNAKOSHI, Tokyo (JP)

(73) Assignee: NEC Corporation, Minato-ku, Tokyo (JP)

(21) Appl. No.: 15/780,707

(22) PCT Filed: Dec. 6, 2016
(86) PCT No.: PCT/JP2016/086185

§ 371 Date: Jun. 1, 2018

(30) Foreign Application Priority Data
Dec. 8, 2015 (JP) 2015-239089

(51) Int. Cl. G06F 17/30; G06F 17/21

(52) U.S. Cl. CPC G06F 17/30292; G06F 17/218; G06F 17/30312; G06F 17/30469

(57) ABSTRACT

A document processing apparatus includes a first storage that stores schema information that identifies a schema expressing a structure of information contained in a structured document, and shape information that identifies a shape expressing a restriction of the information; a second storage that stores the schema information, a concrete query that represents a query capable to be issued to a structured document that contains information having a structure of the schema information, and an abstract query that abstractly expresses the concrete query; an inference unit that determines, when unknown schema information is applied to information contained in a structured document, schema information related to shape information having an inheritance relation to shape information applied to the information as related schema information; and a query determination unit that determines, an abstract query inputted for the structured document and a concrete query related to the related schema information, as a concrete query.

### TECHNICAL FIELD

The disclosed subject matter relates to processing of structured documents.

### BACKGROUND ART

It is desirable that a document exchanged within an organization or among organizations is written using a common format. Especially, when the document is processed automatically, in order to extract necessary information from the content of the document, it is important to know the structure of the document. When designing software for automatically processing a document, the structure of the document to be inputted is specified when the software is designed, and a suitable logic for the specified structure is developed.

Various document structures that are suitable for automatic processing are proposed. Among the most typical structured documents is the extensible markup language (XML) document. When the structure of the XML document is known, it is easy to automatically process the reading and writing thereof. Recently, Linked data is actively utilized. Linked data is often written in resource description framework (RDF) structure. XML document and Linked data are allowed to be extended by a user into free structure as long as they do not contain syntax inconsistence. However, software that perform processing to a document having a conventional structure sometimes cannot process a document having a structure freely extended by a user. This happens because when the software is designed, inputting such a document with extended structure is not expected. Therefore, restricting extensions by a user is considered. However, a standard structure proposed by a standardization body lacks of expression ability when expressing various information utilized in various corporate cultures and various business processes.

In order to solve this problem, the standard proposed by a standardization body is sometimes extended originally by each organization and standardized document processing is sometimes created. The document can be sufficiently processed automatically by software as long as the document is in the standard which should be called an organization standard. In other words, interoperation of a document within an organization is made possible by organization standards.

An example of a technique corresponding to such a problem is described in Patent Literature 1. In the related art described in Patent Literature 1, a document structure is searched for, and document structure corresponding to the keyword is outputted from among a plurality of structured documents stored in a database. The creator of the structured documents can utilize this related art to search for a document structure that has similar content to the document they are preparing, and prepare a structured document utilizing the found document structure. As a result, the related art suppresses the flooding of various document structures.

### CITATION LIST

### Patent Literature

[Patent Literature 1] Japanese Unexamined Patent Application Publication No. 2004-126640

### SUMMARY OF INVENTION

### Technical Problem

However, the above-described organization standard and related art have the following problems.

The organization standard enables interoperation of a document within an organization, however, it is difficult to ensure interoperability of the document among organizations. This is because a different organization standard is normally supposed to exist for each organization. Therefore, a software for processing a document structure based on an organization standard of an organization is not able to automatically process an unknown document structure based on an organization standard utilized in another organization. Especially this problem is prominent when considering the changing of an organization with which the document is interoperated.

Further, the related art described in Patent Literature 1 assumes the creator of the structured document searches for the desired document structure from a single database. However, the creator of the structured document belonging to a different organization does not always search for a document structure of the documents he wants to create from a single database. Therefore, a software for processing a document structure created using the related art in an organization is not able to automatically process an unknown document structure created in another organization. Especially this problem is prominent when considering the changing of an organization with which the documents are interoperated.

The disclosed subject matter is made in order to solve the above-mentioned problems. The purpose of the disclosed subject matter is to provide a technique that enables automatic processing of a structured document having an unknown document structure.

### Solution to Problem

A document processing apparatus includes: a first storage that relates and stores schema information that identifies a schema expressing a structure of information contained in a structured document, and shape information that identifies a shape expressing a restriction of the information; a second storage that relates and stores the schema information, a concrete query that represents a query capable to be issued to a structured document that contains information having a structure expressed by the schema information, and an abstract query that abstractly expresses the concrete query; an inference unit that determines, in a case unknown schema information is applied to information contained in a structured document to be processed, in the first storage, schema information related to shape information having an inheritance relation to shape information applied to the information as related schema information related to the unknown schema information; and a query determination unit that determines, in the second storage, an abstract query inputted for the structured document to be processed and a concrete query related to the related schema information, as a concrete query to be issued to the structured document to be processed.

A method of document processing by a computer utilizes a first storage and a second storage. The method utilizes the first storage that relates and stores schema information that identifies a schema expressing a structure of information contained in a structured document, and shape information that identifies a shape expressing a restriction of the information, and the method utilizes the second storage that relates and stores the schema information, a concrete query that represents a query capable to be issued to a structured document including information having a structure expressed by the schema information, and an abstract query that abstractly expresses the concrete query.

The method by the computer includes, in a case unknown schema information is applied to information contained in a structured document to be processed, determining, in the first storage, schema information related to schema information having an inheritance relation with shape information applied to the information as related schema information related to the unknown schema information; and determining, in the second storage, an abstract query inputted for the structured document to be processed and a concrete query related to the related schema information, as a concrete query to be issued to the structured document to be processed.

A storage medium stores a program. The program utilizes: a first storage that relates and stores schema information that identifies a schema expressing a structure of information contained in a structured document, and shape information that identifies a shape expressing a restriction of the information; and a second storage that relates and stores the schema information, a concrete query that represents a query capable to be issued to a structured document including information having a structure expressed by the schema information, and an abstract query that abstractly expresses the concrete query.

The program causes a computer to execute: an inheritance relation inference step that determines, in a case unknown schema information is applied to information contained in a structured document to be processed, an inheritance relation inference step that determines, in the first storage, schema information related to shape information that has an inference relation with shape information applied to the information as related schema information related to the unknown schema information; and a query determination step that determines, in the second storage, an abstract query inputted for the structured document to be processed and a concrete query related to the related schema information, as a concrete query to be issued to the structured document to be processed.

### Advantageous Effects of Invention

The disclosed subject matter is capable of providing a technique that enables automatic processing of a structured document having an unknown document structure.

### BRIEF DESCRIPTION OF DRAWINGS

FIG. 1 is a block diagram showing a configuration of the document processing apparatus in the first example embodiment of the disclosed subject matter.

FIG. 2 is a diagram showing an example of a hardware configuration of the document processing apparatus in the first example embodiment of the disclosed subject matter.

FIG. 3 is a flowchart describing an operation of the document processing apparatus in the first example embodiment of the disclosed subject matter.

FIG. 4 is a block diagram showing a configuration of the document processing apparatus in the second example embodiment of the disclosed subject matter.

FIG. 5 is a flowchart showing an operation of the document processing apparatus in the second example embodiment of the disclosed subject matter.

FIG. 6 is a diagram showing an example of information stored in a second storage in the second example embodiment of the disclosed subject matter.

FIG. 7 is a diagram showing an example of a structured document including information to which a known schema information is applied in the second example embodiment of the disclosed subject matter.

FIG. 8 is a diagram showing an example of information stored in the first storage in the second example embodiment of the disclosed subject matter.

FIG. 9 is a diagram showing an example of a structured document to which an unknown schema information is applied in the second example embodiment of the disclosed subject matter.

FIG. 10 is a diagram showing an example of a definition of a shape in the second example embodiment of the disclosed subject matter.

### DESCRIPTION OF EMBODIMENTS

Hereinafter, with reference to the figures, the example embodiments of the disclosed subject matter are described in detail.

### First Example Embodiment

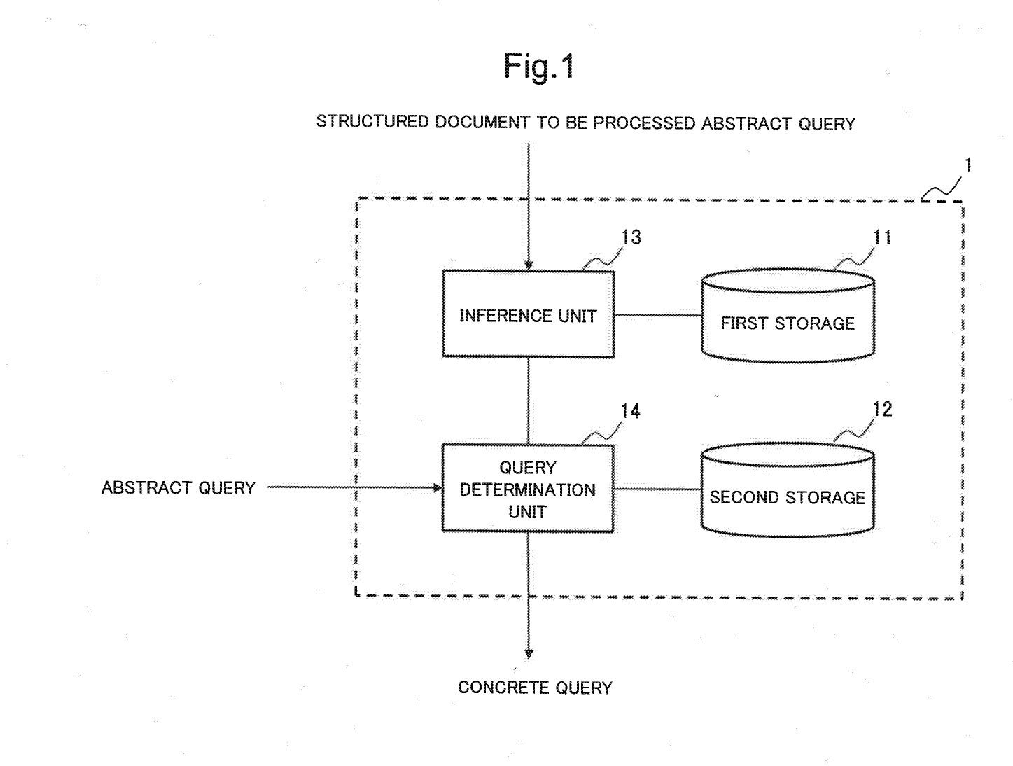

FIG. 1 shows the function block configuration of the document processing apparatus 1 in the first example embodiment of the disclosed subject matter. In FIG. 1, the document processing apparatus 1 includes a first storage 11, a second storage 12, an inference unit 13 and a query determination unit 14.

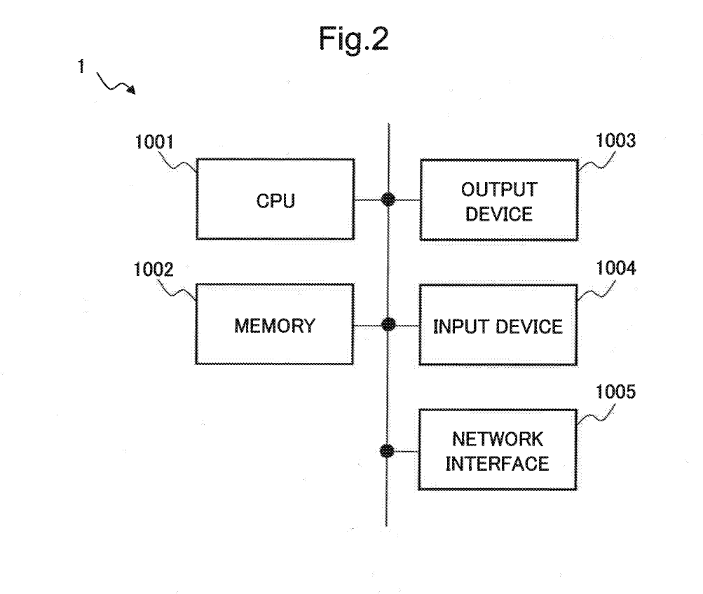

The document processing apparatus 1 is an information processing apparatus that is capable of processing a structured document, and can be configured with hardware elements shown in FIG. 2. In FIG. 2, the document processing apparatus 1 includes a central processing unit (CPU) 1001, a memory 1002, an output device 1003, an input device 1004 and a network interface 1005. The memory 1002 is configured with a random access memory (RAM), a read only memory (ROM), an auxiliary storage device (hard disk or the like) or the like. The output device 1003 is configured with a device that outputs information such as a display, a printer or the like. The input device 1004 is configured with a device that accepts input by operations of a user such as a keyboard, a mouse, or the like. The network interface 1005 is an interface that connects to the network composed of the Internet, wired local area network (LAN), wireless LAN, public network, mobile data communication network or the combination thereof. In this case, the first storage 11 and the second storage 12 are composed of the memory 1002. The inference unit 13 is composed of the network interface 1005 and the CPU 1001 that read and execute the computer program stored in the memory 1002. The query determination unit 14 is composed of input device 1004 and the CPU 1001 that reads and executes the computer program stored in the memory 1002. Note that the hardware configuration of the document processing apparatus 1 and each of the function blocks thereof are not limited to the above-described configuration.

Each of the function blocks will be described.

Schema information and shape information are related and stored in the first storage 11.

Here, a schema refers to the structure of the information contained in a structured document. Schema information refers to the information for identifying such a schema. For example, in the case of an RDF structured document, the schema information to identify the schema of the document is expressed with uniform resource identifier (URI). The URI is stored with the definition content of the schema. Hereinafter, the schema information that identifies a schema expressing the structure of a piece of information is also referred to as schema information applied to the information.

A shape refers to the restriction of the information contained in a structured document. Shape information is a piece of information for identifying such a shape. For example, in the case of an RDF structured document, the shape information to identify the shape of the document is expressed with uniform resource identifier (URI). The URI is stored with the definition content of the shape. Hereinafter, the shape information that identifies a shape expressing the restriction of a piece of information is also referred to as shape information applied to the information.

Here, a shape is defined for the component of the information to which the shape information is applied. Therefore, the shape information and the schema information that is applied to the information to which the shape information is applied can be related. Note that the first storage 11 may preliminarily relate and store the set of shape information and schema information that are inputted by an administrator or the like via the input device 1004.

The second storage 12 relates and stores schema information, a concrete query, and an abstract query. The concrete query refers to a query that can be issued to a structured document. For example, the concrete query may be something that expresses a processing to retrieve desired information from a structured document. The concrete query may be something that expresses a processing to store and update desired information on a structured document. The abstract query is a query abstractly expressing a concrete query.

On a structured document, a concrete query that can be issued to the information to which the schema information is applied is expressed, according to the schema expressed by the schema information. Therefore, the schema information, the concrete query that can be issued to the information to which the schema information is applied, and an abstract query thereof can be related. Note that the second storage 12 may preliminarily relate and store the set of schema information a concrete query and an abstract query that are inputted by an administrator or the like via the input device 1004.

In the case unknown schema information is applied to the information contained in a structured document to be processed, the inference unit 13 determines the related schema information of the unknown schema information, on the basis of the inheritance relation of the shape information that is applied to the information.

Here, a piece of schema information is referred to as unknown schema information when the concrete query of the information to which the schema information is applied is unknown. The related schema information refers to the schema information whose structure has a possibility to match at least partially with the unknown schema information. A concrete query that can be issued to the related schema information is highly possible to be able to be issued to the unknown schema information.

More specifically, the inference unit 13 determines whether the schema information applied to the information contained in the structured document to be processed is unknown or known. In the example embodiment, whether the schema information is unknown or known can be determined by whether the schema information is stored in one of the first storage 11 and the second storage 12 or not. Note that the schema information applied to the information contained in the structured document to be processed can be acquired by analyzing the content of the structured document to be processed.

More specifically, the inference unit 13 determines the shape information applied to the information contained in the structured document to be processed, in the case unknown schema information is applied to the information contained in the structured document to be processed. Note that the shape information applied to the information contained in the structured document to be processed can be acquired by analyzing the content of the structured document to be processed.

The inference unit 13 acquires shape information having an inheritance relation to the specified shape information. Here, having an inheritance relation refers to having another piece of shape information as the parent or ancestor in the definition of the piece of shape information. The inheritance relation of the shape information corresponding to the information contained in the structured document can be acquired based on the definition of the shape information. The storage location of the definition of such shape information can be acquired by analyzing the content of the structured document. When the storage location of the definition of the shape information indicates a location on the network, the inference unit 13 may access the storage location via the network interface 1005.

The inference unit 13 determines, in the first storage 11, as the related schema information, the schema information related to the shape information having an inheritance relation to the shape information applied to the information contained in the structured document to be processed. Note that a case can also be assumed that the shape information that is the parent of the shape information is not stored in the first storage 11. In this case, the inference unit 13 may repeat the processing to acquire the shape information that is the parent of the already acquired information until the shape information stored in the first storage 11 is acquired.

The query determination unit 14 acquires, as the input, an abstract query of the information contained in the structured document to be processed. For example, the abstract query may be inputted via the input device 1004. Then, the query determination unit 14 acquires, in the second storage 12, the concrete query that is related to the inputted abstract query and the related schema information. Next, the query determination unit 14 determines the acquired concrete query as the concrete query to be issued to the structured document to be processed. Then, the query determination unit 14 may issue the determined concrete query to the structured document to be processed.

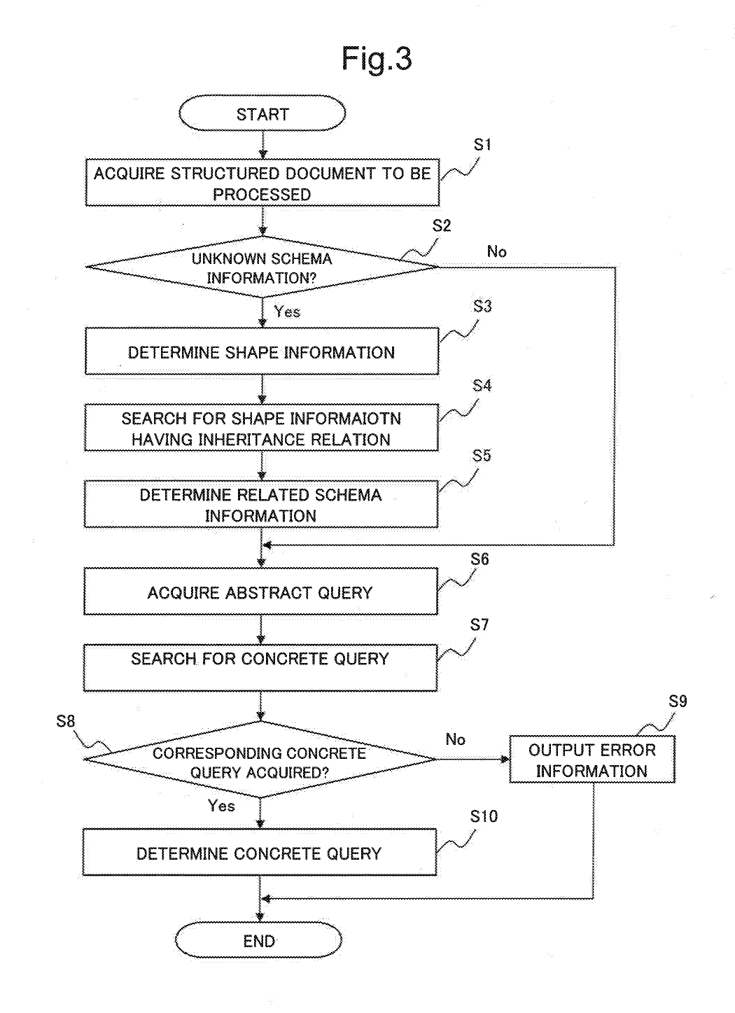

The operation of the document processing apparatus 1 configured as above will be described with reference to FIG. 3.

In FIG. 3, the inference unit 13 acquires the structured document to be processed (step S1).

Then, the inference unit 13 determines whether unknown schema information is applied to the information contained in the structured document to be processed or not (step S2). As described above, the inference unit 13 may determine that the corresponding schema information is unknown when the schema information is not stored in the first storage 11 or the second storage 12, and determine as not unknown (known) when stored.

When the corresponding schema information is not unknown (known), the operation of the document processing apparatus 1 proceeds to step S6.

On the other hand, when the corresponding schema information is known, the inference unit 13 specifies the shape information applied to the information contained in the structured document to be processed (step S3).

Then, within the first storage 11, the inference unit 13 searches for the shape information having an inheritance relation to the shape information specified at step S3 (step S4).

For example, as described above, the inference unit 13 specifies the parent shape information by referring to the definition of the acquired shape information. Then, the inference unit 13 searches for the parent shape information within the first storage 11. Here, when the parent shape information is not stored in the first storage 11, the inference unit 13 further acquires the parent shape information of the already acquired parent shape information by referring to the definition content thereof. As described above, the inference unit 13 repeats the processing to acquire the shape information that is the parent, until the shape information stored in the first storage 11 is acquired.

Then, the inference unit 13 determines, in the first storage 11, as the related schema information of the unknown schema information, the schema information related to the shape information having an inheritance relation (step S5).

Then, the query determination unit 14 acquires, as the input, the abstract query for the information contained in the structured document to be processed (step S6).

Then, the query determination unit 14 searches, within the second storage 12, for the concrete query that is related to the inputted abstract query and the related schema information or the known schema information (step S7). Here, the related schema information is the related schema information determined in step S5. In addition, the known schema information is the schema information in the case determined as known in step S2.

Here, in the case the corresponding concrete query cannot be found within the second storage 12 (No in step S8), the query determination unit 14 outputs error information (step S9).

On the other hand, when the corresponding concrete query is found in the second storage 12 (Yes in step S8), the query determination unit 14 determines the found concrete query as the concrete query to be issued to the structured document to be processed (step S10).

This is the end of the operation of the document processing apparatus 1.

Next, the effect of the first example embodiment of the disclosed subject matter will be described.

The document processing apparatus of the first example embodiment of the disclosed subject matter is capable of automatically processing of structured documents having unknown document structures.

The reason will be described. In the example embodiment, in the first storage, the schema information that identifies the schema expressing the structure of the information contained in the structured document, and the shape information that identifies the shape expressing the restriction of the information are related and stored. In addition, in the second storage, schema information, a concrete query that expresses the query capable to be issued to the structured document including the information based on the schema information, and an abstract query that abstractly expresses the concrete query are related and stored. The inference unit determines the shape information applied to the information, in the case unknown schema information is applied to the information contained in the structured document to be processed. Then, the inference unit determines, in the first storage, the schema information related to the shape information having an inheritance relation to the shape information applied to the information as the related schema information. An abstract query of the structured document to be processed is inputted to the query determination unit. Then, in the second storage, the query determination unit determines the concrete query that is related to the inputted abstract query and the related schema information as the concrete query to be issued to the structured document to be processed.

As described above, in the example embodiment, using the inheritance relation of the shape information, a known schema information that is related to the unknown schema information can be determined. The known schema information that is determined as having a relation is highly possible to have a structure that partly matches the unknown schema information. Therefore, the example embodiment can issue, to a structured document including information to which unknown schema information is applied, a concrete query that is stacked and related to the known schema information. As a result, the example embodiment can perform data processing such as extraction and registration to a structured document including information to which unknown schema information is applied without newly designing a software.

### Second Example Embodiment

Hereinafter, with reference to the figures, the second example embodiment of the disclosed subject matter will be described in detail. Note that in the figures referred to by the description of the example embodiment, like reference numerals are used to the configuration that are the similar to that of the first example embodiment of the disclosed subject matter and steps that operates in the similar way as that of the first example embodiment, and the detailed descriptions thereof are omitted.

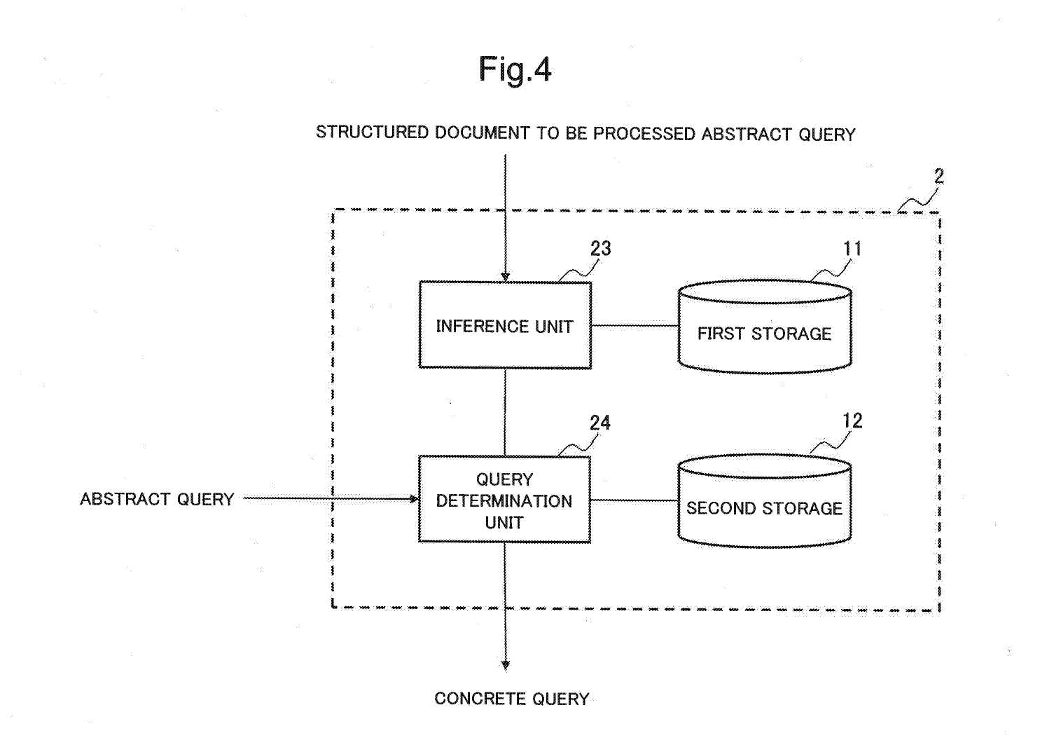

FIG. 4 shows the configuration of the document processing apparatus 2 of the second example embodiment of the disclosed subject matter. In FIG. 4, the document processing apparatus 2 differs from the document processing apparatus 1 of the first example embodiment of the disclosed subject matter in that including an inference unit 23 instead of the inference unit 13 and including a query determination unit 24 instead of the query determination unit 14.

The document processing apparatus 2 and each of the function blocks thereof can be configured by the hardware elements of the first example embodiment of the disclosed subject matter described with reference to FIG. 2. Note that the hardware configuration of the document processing apparatus 2 and each of the function blocks thereof are not limited to the above-described configuration.

The inference unit 23 is configured as follows, in addition to the configuration similar to the inference unit 13 in the first example embodiment of the disclosed subject matter. The inference unit 23 relates and stores, to the first storage 11, the shape information applied to the information contained in the structured document to be processed and the schema information that is applied to the information. Note that, here, registration refers to storing in the first storage 11. As a result, the schema information that was unknown in the structured document to be processed is now a known schema information that is related to the shape information.

In addition, the inference unit 23 relates and stores, to the first storage 11, the shape information applied to the information contained in the structured document to be processed of which the related schema information is determined and the related schema information. As a result, if the shape information which inherits the shape information of this time is applied to the information, contained in the structured documents to be processed later, to which unknown schema information is applied, the inference unit 23 is able to rapidly acquire the related schema information.

Note that, in this case, within the first storage 11, for the same piece of shape information, a case that a plurality of storing of registrations each having a different related schema information is possible. In other words, one of the different pieces of schema information is the schema information that used to be unknown that is applied to the information contained in the structured document to be processed this time, and the other piece is the schema information that is determined to be the related schema information of the schema information that used to be unknown. In this case, when the corresponding shape information is applied to the information contained in the structured document to be processed later, the inference unit 23 may determine any one of the plurality of pieces of schema information as the related schema information. Alternatively, the inference unit 23 may determine a plurality of pieces of schema information as the related schema information in the case the corresponding shape information is applied to the information contained in the structured document to be processed later. In this case, the query determination unit 24 may search for the concrete query from the second storage 12 using each of the pieces of the related schema information, and choose an appropriate concrete query.

The query determination unit 24 is configured as follows, in addition to the configuration similar to the query determination unit 14 in the first example embodiment of the disclosed subject matter. There is a case that an abstract query inputted for the information contained in the structured document to be processed and a concrete query that is related to the related schema information are not stored in the second storage 12. In this case, the query determination unit 24 determines the concrete query inputted from outside as the concrete query to be issued to the structured document to be processed. In this case, the concrete query is inputted via the input device 1004, for example.

The query determination unit 24 relates and stores, to the second storage 12, the concrete query determined against the information contained in the structured document to be processed, the schema information applied to the information, and the abstract query inputted for the information. Note that, here, registration refers to storing in the second storage 12. Therefore, when unknown schema information is applied to the information, the query determination unit 24 can stack the abstract query and concrete query, regarding the schema information that used to be unknown as known. In addition, when known schema information is applied to the information, the query determination unit 24 can additionally stack, against the known schema information, the abstract query and the concrete query that has not been stacked yet.

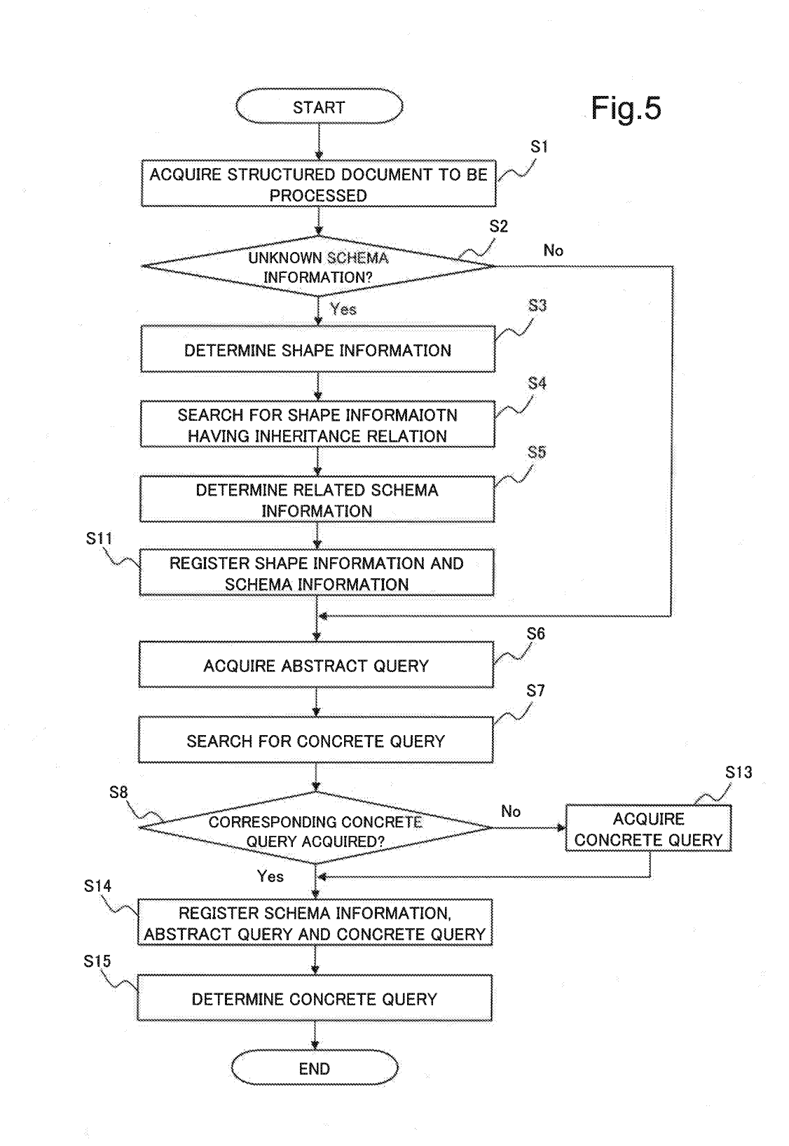

The operation of the document processing apparatus 2 configured as above will be described with reference to FIG. 5.

In FIG. 5, in steps S1 to S5, the document processing apparatus 2 operates in the similar way as the first example embodiment of the disclosed subject matter, and determines the related schema information of the unknown schema information.

Next, for the information contained in the structured document to be processed, the inference unit 23 relates and stores, to the first storage 11, the shape information that is applied to the information and the schema information that is applied to the information. In addition, the inference unit 23 relates and stores, to the first storage 11, the shape information applied to the information and the related schema information that is determined (step S11).

Then, from steps S6 to S7, the document processing apparatus 2 operates in the similar way as the first example embodiment of the disclosed subject matter, and searches for the inputted abstract query and a concrete query that is related to the related schema information or the known schema information.

Here, when such desired concrete query is not acquired (No in step S8), the query determination unit 24 acquires, as the input, the concrete query for the information contained in the structured document to be processed (step S13).

Then, on the second storage 12, the query determination unit 24 relates and stores the inputted concrete query, the schema information applied to the information, and the abstract query inputted in step S6 (step S14).

On the other hand, when the corresponding concrete query is acquired (Yes in step S8), the query determination unit 24 performs the step S14. In other words, on the second storage 12, the query determination unit 24 relates and stores the acquired concrete query, the schema information applied to the information, and the abstract query inputted in step S6 (step S14).

Then, the query determination unit 24 determines the concrete query acquired in step S7 or the concrete query inputted in step S13 as the concrete query to be issued to the structured document to be processed (step S15).

This is the end of the operation of the document processing apparatus 2.

Next, an example of the operation of the document processing apparatus 2 will be described with examples.

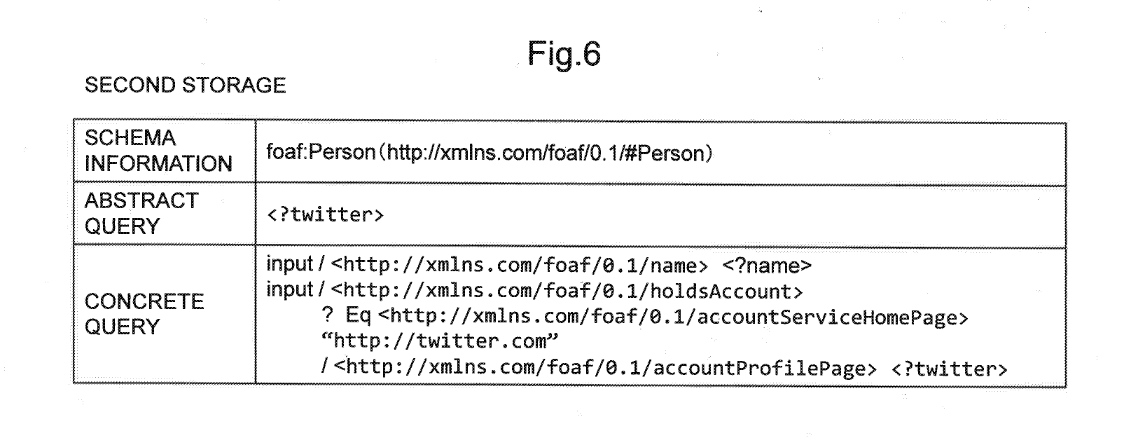

In the example, as shown in FIG. 6, on the second storage 12, schema information, an abstract query, and a concrete query are related and stored.

Note that in the figures FIG. 6 and later and the description below, “xxxx (http://yyyy)” refers to the schema information or shape information that identifies the schema or shape using the URI written between the brackets. The URI also expresses the storage location of the definition, in addition to identifying the schema or shape. The “xxxx” represents a part of the URI, simplified by defining a prefix. Schema information or shape information “xxxx (http://yyyy)” is also simply expressed with “xxxx”.

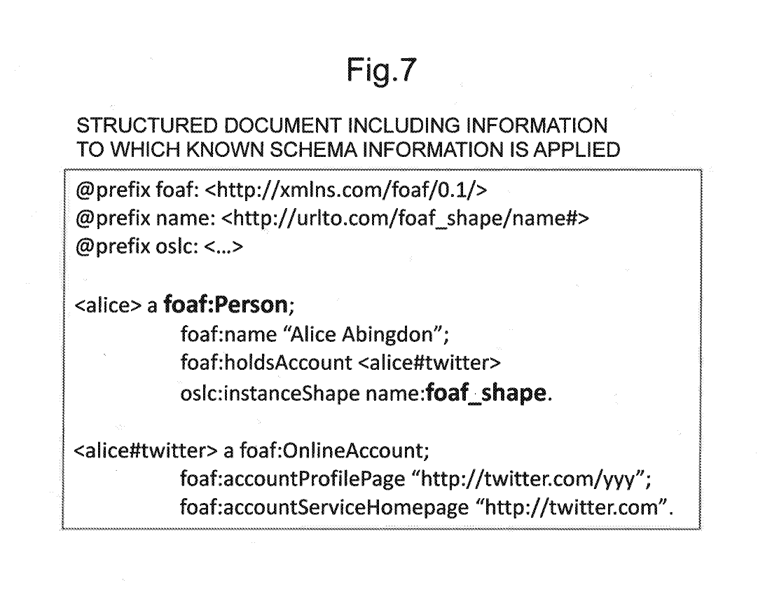

The concrete query shown in FIG. 6 is the query that is capable of being issued to the RDF structured document containing the information to which the schema information “foaf:Person” is applied. An example of an RDF structured document that is the target of the concrete query is shown in FIG. 7.

The RDF structured document of FIG. 7 will be described. The RDF structured document is described in Turtle language. In FIG. 7, the resource “<alice>” is expressed using schema information “foaf:Person”. Also, .shape information “foaf_shape” is applied to the resource “<alice>”. Note that schema information applied to a resource is indicted by the object of the RDF triple specifying the type of the resource. Shape information applied to a resource is indicted by the value of the “instanceShape” attribute of the resource.

The concrete query of FIG. 6 will be described. This concrete query searches for a resource to which the schema information “foaf:OnlineAccount” is applied, out of the resources in FIG. 7 specified as the value of the “holdsAccount” attribute of the resources to which the schema information “foaf:Person” is applied. Then, the concrete query extracts the value of the “accountProfilePage” attribute from the found resources that have “http://twitter.com” as the value of the “accountServiceHomepage” attribute. Note that, here, the concrete query of FIG. 6 is written in Diesel language that is one of the query languages for the RDF structured documents. Diesel language is one of the domain-specific language (DSLs) that provides a simple way of describing the standardized query language sparql protocol and RDF query language (SPARQL) for RDF structured documents.

The abstract query of FIG. 6 will be described. The abstract query “<?twitter>” abstractly expresses the above-described concrete query. That is to say, the abstract query abstractly expresses a processing of extracting a twitter (stored trademark) account from a structured document.

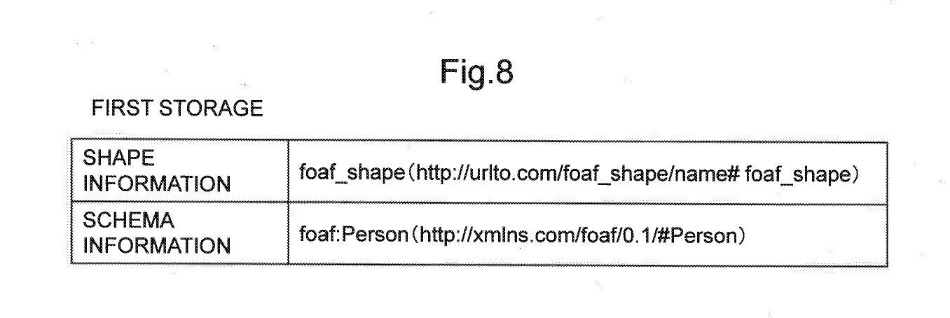

Also, in the example, as shown in FIG. 8, shape information “foaf_shape” and schema information “foaf:Person” are related and stored in the first storage 11.

As described above, the RDF structured document of FIG. 7 contains information to which known schema information is applied.

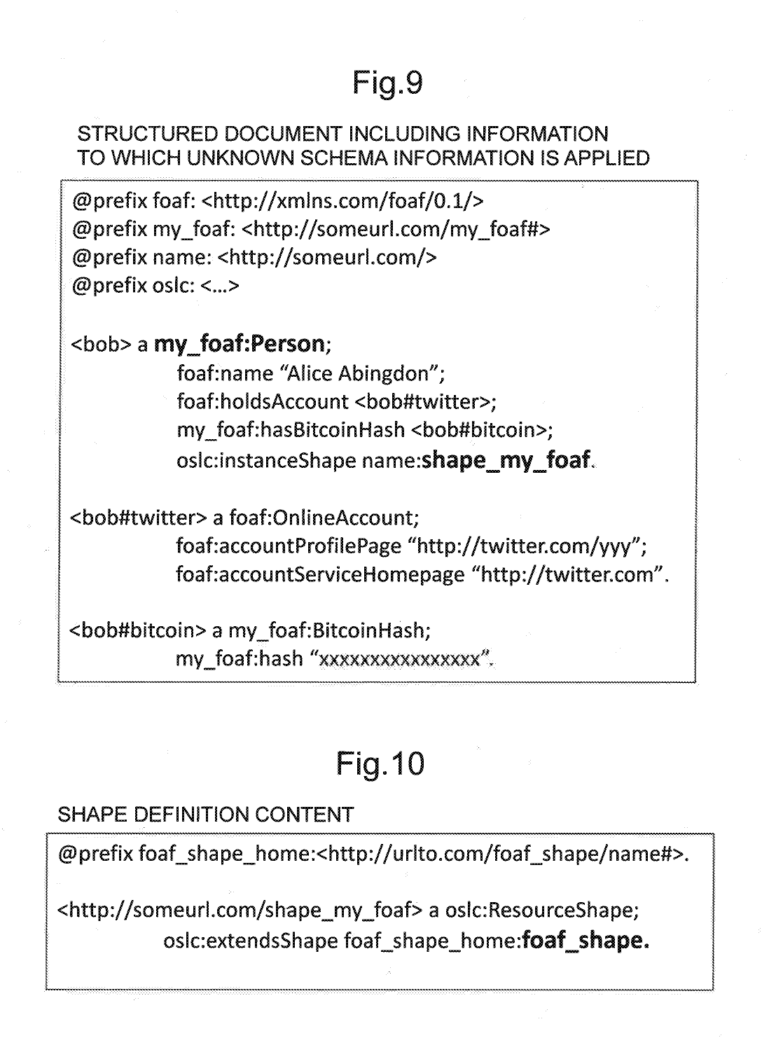

The inference unit 23 is assumed to acquire the RDF structured document shown in FIG. 9 in a state where the above-described information is stored in the first storage 11 and the second storage 12 (step S1).

In FIG. 9, the resource “<bob>” is expressed using schema information “my_foaf:Person”. As described above, schema information applied to a resource can be acquired from the object of the RDF triple specifying the type of the resource. Here, the schema information “my_foaf:Person” is not stored in the first storage 11 in FIG. 8 or the second storage 12 in FIG. 6, and is unknown schema information (Yes in step S2).

Here, the unknown schema information “my_foaf:Person” is actually defined by extending the known schema information “foaf:Person”. However, from the definition content of schema information “my_foaf:Person”, it is unable to know that it is created by extending “foaf:Person”.

Therefore, the inference unit 23 acquires the shape information “foaf_my_shape” applied to the resource “<bob>” to which the unknown schema information is applied (step S3). As mentioned earlier, the shape information applied to a resource can be acquired from the value of the “instanceShape” attribute of the resource.

Next, the inference unit 23 searches for shape information having an inheritance relation to the shape information “foaf_my_shape”. Specifically, the inference unit 23 is assumed to have acquired the definition content of the shape shown in FIG. 10 by accessing the URI of the shape information “http://someurl.com/name#foaf_my_shape”.

FIG. 10 shows that the shape information “shape_my_foaf” is defined by inheriting shape information “foaf_shape”. This can be analyzed by referring to the value of the “extendsShape” attribute in the definition of the shape. Also, this shape information “foaf_shape” is stored in the first storage 11.

Consequently, the inference unit 23 acquires, in the first storage 11, the schema information “foaf:Person” that is related to the shape information “foaf_shape” (step S4).

Then, the inference unit 23 determines the schema information “foaf:Person” as the related schema information of the unknown schema information “foaf_my_shape” (step S5).

Next, the inference unit 23 relates and stores the shape information “foaf_my_shape” and the schema information “my_foaf:Person”, in the first storage 11. Also, the inference unit 23 relates and stores the shape information “foaf_my_shape” and the related schema information “foaf:Person” in the first storage 11 (step S11).

Then, the query determination unit 24 acquires “<?twitter>” that means, as an abstract query, extracting a twitter account (step S6).

Next, the query determination unit 24 searches, in the second storage 12, for an abstract query “<?twitter>” and the concrete query related to the related schema information “foaf_shape” (step S7).

Here, the information shown in FIG. 6 is stored in the second storage 12. The query determination unit 24 acquires the concrete query shown in FIG. 6, as the corresponding concrete query (Yes in step S8).

Then, the query determination unit 24 relates and stores the schema information “my_foaf:Person”, the abstract query “<?twitter>”, and the concrete query shown in FIG. 6 in the second storage 12 (step S14).

At last, the query determination unit 24 determines the found concrete query as the concrete query of the RDF the structured document in FIG. 9, and issues it (step S15).

This is the end of the description of the detailed operation of the document processing apparatus 2.

Next, the effect of the second example embodiment of the disclosed subject matter will be described.

The document processing apparatus of the second example embodiment of the disclosed subject matter is able to determine a concrete query for an unknown document structure, and moreover, the document structure that has been unknown is thereafter regarded as known, and the concrete query thereof can be rapidly determined.

The reason will be described. The reason is that, in the example embodiment, in addition to the configuration of the first example embodiment of the disclosed subject matter, the inference unit relates and stores, to the first storage, the shape information and the schema information that are applied to the information contained in the structured document to be processed. Also, the inference unit relates and stores, to the first storage, the shape information applied to the information contained in the structured document to be processed and the related schema information that is determined. Also, in the case the inputted abstract query and the concrete query related to the related schema information are not stored in the second storage, the query determination unit acquires, as an input, the concrete query to be issued to the structured document to be processed. Then, the query determination unit relates stores, in the second storage, the schema information applied to the information contained in the structured document to be processed, the inputted abstract query and the determined concrete query.

Therefore, in the example embodiment, it is able to process structured documents that contain information to which schema information that used to be unknown, treating as containing information to which known schema information is applied afterwards. As a result, in the example embodiment, the concrete query can be more rapidly determined for the structured documents to be processed afterwards.

Also, the example embodiment is able to rapidly determine related schema information for the structured document to be processed, that contain information applied with shape information inheriting shape information that used to be applied, corresponding to the schema information that used to be unknown, afterwards. As a result, the example embodiment can rapidly determine the concrete query for such structured documents afterwards.

Also, in the example embodiment, the schema information that used to be unknown contained in the structured document to be processed is related to the concrete query thereof and is stored, and known schema information is related to a new concrete query and additionally stored. As described above, the example embodiment stacks the sets of schema information and query while determining concrete query for the structured document to be processed. As a result, the example embodiment can determine afterwards a more appropriate query as a concrete query that can be issued to the structured document to be processed containing information to which unknown schema information is applied.

Note that the description above is mainly made with examples that a single piece of schema information is applied to information contained in the structured document in each of the example embodiments of the disclosed subject matter. Not limited to this, the example embodiment can be executed in a case that a plurality of pieces of schema information are applied to information contained in the structured document, and in a case that a plurality of pieces of information each of which is applied with different schema information. In the case, the example embodiment may operate in the similar way as the example embodiment for each of the plurality of pieces of schema information.

In each example embodiment of the disclosed subject matter, the descriptions above were made with examples that the structured documents are RDF structured documents. However, the format of the structured documents is limited to this, and may be other formats. Note that, in the example embodiment, it is difficult to acquire the inheritance relation of the schema information. However, in the case processing of structured documents that have formats whose inheritance relation of shape information can be acquired, the above-described effects are especially exhibited.

In addition, in each of the above-described example embodiments of the disclosed subject matter, the description was made with examples that the RDF structured documents and their concrete queries are described in a specific language. RDF structured documents and concrete queries described in other languages may be adopted as the structured documents, not limited to the specific language.

In each of the above-described example embodiments of the disclosed subject matter, the document processing apparatus and each of the function blocks thereof may be distributed to a plurality of apparatuses and realized.

In each of the above-described example embodiments of the disclosed subject matter, the operations of the document processing apparatus described with references to flowcharts may be stored in a storage device (storage medium) of a computer as computer program of the disclosed subject matter. The computer program may be read and executed by the CPU. In this case, the disclosed subject matter is composed of the code of the computer program or the storage medium.

Each of the above-described example embodiments may be combined and executed accordingly.

The disclosed subject matter was described above with each of the of the example embodiments. However, the disclosed subject matter is not limited to the above-described example embodiments. In other words, within the scope of the disclosed subject matter, the disclosed subject matter may be applied with various aspects that may be understood by a person skilled in the art.

This application claims the benefit of Japanese Patent Application No. 2015-239089, filed on Dec. 8, 2015, the entire disclosure of which is incorporated by reference herein.

### REFERENCE SIGNS LIST

1, 2 Document Processing Apparatus
11 First Storage
12 Second Storage
13, 23 Inference Unit
14, 24 Query Determination Unit
1001 CPU
1002 Memory
1003 Output Device
1004 Input Device
1005 Network Interface

What is claimed is:

1. A document processing apparatus comprising:
a first storage that relates and stores schema information that identifies a schema expressing a structure of information contained in a structured document, and shape information that identifies a shape expressing a restriction of the information;
a second storage that relates and stores the schema information, a concrete query that represents a query capable to be issued to a structured document that contains information having a structure expressed by the schema information, and an abstract query that abstractly expresses the concrete query;
an inference unit that determines, in a case unknown schema information is applied to information contained in a structured document to be processed, in the first storage, schema information related to shape information having an inheritance relation to shape information applied to the information as related schema information related to the unknown schema information; and
a query determination unit that determines, in the second storage, an abstract query inputted for the structured document to be processed and a concrete query related to the related schema information, as a concrete query to be issued to the structured document to be processed.

2. The document processing apparatus according to claim 1, wherein the inference unit relates and stores, to the first storage, shape information applied to information contained in the structured document to be processed and schema information that is applied to the information.

3. The document processing apparatus according to claim 1, wherein the inference unit relates and stores, to the first storage, shape information applied to information contained in the structured document to be processed and the related schema information.

4. The document processing apparatus according to claim 1, wherein the query determination unit determines, in the second storage, an abstract query inputted for the structured document to be processed, and, when a concrete query that is related to the related schema information cannot be acquired, determines an externally inputted concrete query as a concrete query to be issued to the structured document to be processed.

5. The document processing apparatus according to claim 1, wherein the query determination unit relates and stores, to the second storage, a concrete query determined against the structured document to be processed, a piece of schema information applied to the information, and an abstract query inputted for the information.

6. The document processing apparatus according to claim 1, wherein a resource description framework (RDF) document is applied as the structured document.

7. A method of document processing by a computer utilizes a first storage and a second storage,
the first storage relating and storing schema information that identifies a schema expressing a structure of information contained in a structured document, and shape information that identifies a shape expressing a restriction of the information; and
the second storage relating and storing the schema information, a concrete query that represents a query capable to be issued to a structured document including information having a structure expressed by the schema information, and an abstract query that abstractly expresses the concrete query;
the method by the computer comprising:
in a case unknown schema information is applied to information contained in a structured document to be processed, determining, in the first storage, schema information related to schema information having an inheritance relation with shape information applied to the information as related schema information related to the unknown schema information; and
determining, in the second storage, an abstract query inputted for the structured document to be processed and a concrete query related to the related schema information, as a concrete query to be issued to the structured document to be processed.

8. A non-transitory computer readable storage medium storing a program, the program utilizing:
a first storage that relates and stores schema information that identifies a schema expressing a structure of information contained in a structured document, and shape information that identifies a shape expressing a restriction of the information; and
a second storage that relates and stores the schema information, a concrete query that represents a query capable to be issued to a structured document including information having a structure expressed by the schema information, and an abstract query that abstractly expresses the concrete query;
the program causing a computer to execute:
determining, in a case unknown schema information is applied to information contained in a structured document to be processed, determining, in the first storage, schema information related to shape information that has an inference relation with shape information applied to the information as related schema information related to the unknown schema information; and
determining, in the second storage, an abstract query inputted for the structured document to be processed and a concrete query related to the related schema information, as a concrete query to be issued to the structured document to be processed.
